(19) United States
(12) Patent Application Publication
(10) Pub. No.: US 2026/0286109 A1
(43) Pub. Date: Sep. 24, 2026

(54) RUBBER COMPOSITION FOR RIM STRIP AND PNEUMATIC TIRE USING THE SAME

(71) Applicant: Toyo Tire Corporation, Itami-shi (JP)

(72) Inventor: Masataka KUMANO, Itami-shi (JP)

(73) Assignee: Toyo Tire Corporation, Itami-shi (JP)

(21) Appl. No.: 19/561,768

(22) Filed: Mar. 10, 2026

(30) Foreign Application Priority Data
Mar. 19, 2025 (JP) 2025-044590

(51) Int. Cl. C08L 15/00; B60C 1/00; B60C 15/06; C08K 3/04; C08K 3/06; C08K 3/36

(52) U.S. Cl. CPC C08L 15/00; B60C 15/06; C08K 3/04; C08K 3/06; C08K 3/36; B60C 2001/005; B60C 2015/0614; C08K 2201/006; C08L 2205/035; C08L 2312/00

(57) ABSTRACT

A rubber composition for a rim strip according to an embodiment contains: a rubber component containing a tin-modified polybutadiene rubber; silica; carbon black having a nitrogen adsorption specific surface area (N₂SA) of 35 m²/g to 100 m²/g; a vulcanization accelerator; and sulfur. The vulcanization accelerator is contained such that a mass ratio of the vulcanization accelerator to the sulfur is 0.40 to 0.60.

### BACKGROUND OF THE INVENTION

### 1. Field of the Invention

The present invention relates to a rubber composition for a rim strip and a pneumatic tire using the same.

### 2. Description of Related Art

It is known to use a tin-modified polybutadiene rubber as a rubber component of a rubber composition. For example, JP2006-63143A describes a rubber composition for a sidewall or a clinch, which contains, as a rubber component, a tin-modified polybutadiene rubber that is polymerized using a lithium initiator and has a tin atom content of 50 ppm to 3000 ppm, a vinyl bond content of 5 weight % to 50 weight %, and a molecular weight distribution (Mw/Mn) of 2 or less.

JP2012-46611A describes a rubber composition for a canvas chafer, which contains, as a rubber component, at least one selected from the group consisting of a butadiene rubber containing 1,2-syndiotactic polybutadiene crystals, a butadiene rubber having a cis content of 90 mass % or more, and a tin-modified butadiene rubber polymerized with a lithium initiator, having a tin atom content of 50 ppm to 3000 ppm, a vinyl bond content of 5 mass % to 50 mass %, and a molecular weight distribution of 2 or less.

### SUMMARY OF THE INVENTION

In recent years, there is an ever-increasing demand for lower fuel consumption of tires. To meet this demand, it is important to achieve low heat generation properties not only in a cap tread that forms a ground contact surface, but also in various tire members such as a rim strip. Generally, methods for improving the low heat generation properties include reducing a compounding amount of a filler such as carbon black, and increasing a crosslinking density of rubber. However, if the compounding amount of a filler such as carbon black is reduced, hardness tends to decrease and handling stability tends to deteriorate. When increasing the crosslinking density of the rubber, cut resistance tends to deteriorate. Accordingly, it is difficult to achieve both the low heat generation properties and good hardness and cut resistance.

In view of the above, an object of an embodiment of the invention is to provide a rubber composition for a rim strip that can improve low heat generation properties while maintaining hardness and cut resistance, and a pneumatic tire using the same.

The invention includes embodiments shown below.

[1] A rubber composition for a rim strip, containing:
a rubber component containing a tin-modified polybutadiene rubber;
silica;
carbon black having a nitrogen adsorption specific surface area (N₂SA) of 35 m²/g to 100 m²/g;
a vulcanization accelerator; and
sulfur, in which
a mass ratio of the vulcanization accelerator to the sulfur is 0.40 to 0.60.

[2] The rubber composition for a rim strip according to [1], in which
relative to 100 parts by mass of the rubber component, a content of the silica is 3 parts by mass to 30 parts by mass, a content of the carbon black is 40 parts by mass to 80 parts by mass, and a content of the sulfur is 1 part by mass to 5 parts by mass.

[3] The rubber composition for a rim strip according to [1] or [2], in which
100 parts by mass of the rubber component contains 40 parts by mass to 80 parts by mass of the tin-modified polybutadiene rubber and 20 parts by mass to 60 parts by mass of a natural rubber.

[4] The rubber composition for a rim strip according to any one of [1] to [3], in which
the silica has a BET specific surface area of 180 m²/g to 230 m²/g.

[5] The rubber composition for a rim strip according to any one of [1] to [4], in which
relative to 100 parts by mass of the rubber component, a total content of the carbon black and the silica is 45 parts by mass to 100 parts by mass.

[6] The rubber composition for a rim strip according to any one of [1] to [5], in which
a content ratio of the carbon black to the silica (carbon black/silica) is 2 to 10 in terms of mass ratio.

[7] The rubber composition for a rim strip according to any one of [1] to [6], in which
the vulcanization accelerator includes a sulfenamide-based vulcanization accelerator.

[8] A pneumatic tire using the rubber composition for a rim strip according to any one of [1] to [7] in a rim strip.

According to the embodiments of the invention, it is possible to improve low heat generation properties while maintaining hardness and cut resistance.

### BRIEF DESCRIPTION OF THE DRAWINGS

FIG. 1 is a half cross-sectional view illustrating an example of a pneumatic tire.

### DESCRIPTION OF EMBODIMENTS

A rubber composition for a rim strip according to the present embodiment (hereinafter, referred to as rubber composition) contains: (A) a rubber component containing a tin-modified polybutadiene rubber; (B) silica; (C) carbon black having a nitrogen adsorption specific surface area (N₂SA) of 35 m²/g to 100 m²/g; (D) a vulcanization accelerator; and (E) sulfur.

### (A) Rubber Component

In the present embodiment, the rubber component contains a tin-modified polybutadiene rubber. The tin-modified polybutadiene rubber is a polybutadiene rubber (BR) modified by a tin compound. The tin-modified polybutadiene rubber is preferably a terminal tin-modified polybutadiene rubber in which a modifying group containing tin (Sn) is introduced into a terminal of the polymer molecule.

Examples of the tin compound include: halogenated tin compounds such as tin tetrachloride, methyltin trichloride, dibutyldichlorotin, and tributylchlorotin; allyltin compounds such as tetraallyltin, diethyldiallyltin, and tetra(2-octenyl) tin; tetraphenyltin; and tetrabenzyltin. These tin compounds may be used alone or in combination of two or more kinds thereof.

In the tin-modified polybutadiene rubber, as a polybutadiene rubber, which is a base for modification, one that is polymerized using an organolithium catalyst is preferable. As the organolithium catalyst, various organolithium compounds generally used in solution polymerization can be used. Examples of the organolithium catalyst include alkyllithium, aryllithium, alkenyllithium, and alkylenedilithium. These organolithium catalysts may be used alone or in combination of two or more kinds thereof.

A polybutadiene rubber having a low cis content is obtained by polymerization using an organolithium catalyst. A cis content in the tin-modified polybutadiene rubber is not particularly limited, and may be, for example, 5 mass % to 50 mass %, 15 mass % to 50 mass %, or 30 mass % to 50 mass %. Here, the cis content refers to a content of a cis-1,4 bond unit in a microstructure of the polybutadiene rubber. A vinyl content (content of a vinyl-1,2 bond unit) in the tin-modified polybutadiene rubber is not particularly limited, and may be, for example, 1 mass % to 25 mass %, 3 mass % to 20 mass %, or 5 mass % to 20 mass %. The cis content and the vinyl content are calculated based on an integration ratio in a 13C-NMR spectrum.

In the present embodiment, the rubber component may solely contain the above-mentioned tin-modified polybutadiene rubber, or may contain other rubber components in addition to the tin-modified polybutadiene rubber. The rubber component is not particularly limited, and various diene rubbers that are commonly used in rubber compositions for tires can be used. The diene rubber refers to a rubber having a repeating unit corresponding to a diene monomer having a conjugated double bond and contains a carbon-carbon double bond in the main chain of the polymer. Note that the content of the diene rubber in the rubber component excluding the tin-modified polybutadiene rubber is preferably 80 mass % or more, more preferably 90 mass % or more, and may be 100 mass %.

Specific examples of the diene rubber include natural rubbers (NR), synthetic isoprene rubbers (IR), butadiene rubbers (BR), styrene-butadiene rubbers (SBR), nitrile rubbers (NBR), chloroprene rubbers (CR), styrene-isoprene copolymer rubbers, butadiene-isoprene copolymer rubbers, and styrene-isoprene-butadiene copolymer rubbers. The concept of these diene rubbers also includes those modified with a functional group by introducing the functional group into a chain end or a main chain as needed, and those modified to achieve desired properties. The functional group preferably contains an oxygen atom and/or a nitrogen atom, and examples thereof include at least one selected from the group consisting of an amino group, a hydroxy group, an alkoxy group, an alkoxysilyl group, an epoxy group, and a carboxy group. These diene rubbers may be used alone or in combination of two or more kinds thereof.

In one embodiment, 100 parts by mass of the rubber component preferably contains 40 parts by mass to 80 parts by mass of the tin-modified polybutadiene rubber and 20 parts by mass to 60 parts by mass of the natural rubber, and more preferably contains 45 parts by mass to 70 parts by mass of the tin-modified polybutadiene rubber and 30 parts by mass to 55 parts by mass of the natural rubber.

### (B) Silica

The rubber composition according to the present embodiment contains silica. Examples of the silica include wet silica and dry silica. Preferably, wet silica such as precipitated silica or gelled silica is used.

In one embodiment, relative to 100 parts by mass of the rubber component, a content of the silica is preferably 3 parts by mass to 30 parts by mass, more preferably 4 parts by mass to 20 parts by mass, and still more preferably 5 parts by mass to 15 parts by mass.

A BET specific surface area of the silica is preferably 180 m²/g to 230 m²/g, and more preferably 190 m²/g to 220 m²/g. Here, the BET specific surface area of the silica is measured in accordance with the multipoint nitrogen adsorption method (BET method) described in JIS K6430:2008.

### (C) Carbon Black

The rubber composition according to the present embodiment contains carbon black having a nitrogen adsorption specific surface area (N₂SA) of 35 m²/g to 100 m²/g. The nitrogen adsorption specific surface area (N₂SA) of the carbon black is preferably 40 m²/g to 95 m²/g, more preferably 50 m²/g to 90 m²/g, and still more preferably 65 m²/g to 85 m²/g. When the nitrogen adsorption specific surface area (N₂SA) of the carbon black is 35 m²/g or more, the hardness, cut resistance, bending fatigue resistance, and abrasion resistance of the vulcanized rubber can be maintained. When the nitrogen adsorption specific surface area (N₂SA) of the carbon black is 100 m²/g or less, the low heat generation properties can be improved. Any carbon black having such an N₂SA may be used, or two or more kinds thereof may be used in combination. Here, the nitrogen adsorption specific surface area (N₂SA) of the carbon black is measured in accordance with JIS K6217-2 Method A: 2017.

As the carbon black having the above N₂SA, for example, HAF grade (N300 series) and FEF grade (N500 series) (all ASTM grades) are preferably used. Any one or a combination of two or more of the carbon black of each grade can be used.

In one embodiment, relative to 100 parts by mass of the rubber component, a content of the carbon black is preferably 40 parts by mass to 80 parts by mass, more preferably 40 parts by mass to 75 parts by mass, and still more preferably 45 parts by mass to 70 parts by mass.

Relative to 100 parts by mass of the rubber component, a total content of the carbon black and the silica is preferably 45 parts by mass to 100 parts by mass, more preferably 50 parts by mass to 90 parts by mass, and still more preferably 55 parts by mass to 80 parts by mass.

A content ratio of the carbon black to the silica, that is, a ratio of the content of the carbon black to the content of the silica (carbon black/silica) is preferably 2 to 10, more preferably 3 to 9, and still more preferably 4 to 8, in terms of mass ratio.

### (D) Vulcanization Accelerator

The rubber composition according to the present embodiment contains a vulcanization accelerator. Examples of the vulcanization accelerator include various vulcanization accelerators such as sulfenamide-based, guanidine-based, thiuram-based, and thiazole-based vulcanization accelerators. Preferably, in one embodiment, the vulcanization accelerator contains a sulfenamide-based vulcanization accelerator. In this case, it is preferable that 50 mass % or more, more preferably 70 mass % or more, and still more preferably 90 mass % or more of the vulcanization accelerator is the sulfenamide-based vulcanization accelerator.

A content of the vulcanization accelerator is not particularly limited, and is preferably 0.4 parts by mass to 3.0 parts by mass, more preferably 0.5 parts by mass to 2.5 parts by mass, and still more preferably 0.6 parts by mass to 2.0 parts by mass, relative to 100 parts by mass of the rubber component.

### (E) Sulfur

The rubber composition according to the present embodiment contains sulfur as a vulcanizing agent. Examples of the sulfur include powdered sulfur, precipitated sulfur, colloidal sulfur, insoluble sulfur, and high dispersing sulfur, which may be oil-treated.

In one embodiment, relative to 100 parts by mass of the rubber component, a content of the sulfur is preferably 1 part by mass to 5 parts by mass, more preferably 1.3 parts by mass to 4 parts by mass, and still more preferably 1.5 parts by mass to 3.5 parts by mass. Note that the amount of the sulfur refers to the pure sulfur content excluding oil, even when oil-treated sulfur is used (the same applies to the following mass ratio (vulcanization accelerator/sulfur))

In the present embodiment, the vulcanization accelerator and the sulfur are compounded such that a mass ratio of the vulcanization accelerator to the sulfur (vulcanization accelerator/sulfur) is 0.40 to 0.60. By adding the silica to the rubber component containing the tin-modified polybutadiene rubber and further specifying the mass ratio of the vulcanization accelerator to the sulfur as described above to control the crosslinking form, it is possible to improve the low heat generation properties while maintaining the hardness, cut resistance, bending fatigue resistance, and abrasion resistance. The mass ratio (vulcanization accelerator/sulfur) is preferably 0.41 to 0.58, and more preferably 0.43 to 0.56.

In addition to the components described above, various additives generally used in rubber compositions, such as oil, wax, zinc oxide, stearic acid, a resin, and a processing aid, can be compounded in the rubber composition according to the present embodiment. Carbon black and other fillers other than the component (C) may be contained within a range that does not impair the effects of the present embodiment.

A content of the oil is not particularly limited, and may be, for example, 0 parts by mass to 10 parts by mass, 0.5 parts by mass to 5 parts by mass, or 1 part by mass to 3 parts by mass, relative to 100 parts by mass of the rubber component.

A content of the wax is not particularly limited, and may be, for example, 0 parts by mass to 10 parts by mass, 0.5 parts by mass to 5 parts by mass, or 1 part by mass to 4 parts by mass, relative to 100 parts by mass of the rubber component.

A content of the zinc oxide is not particularly limited, and may be, for example, 0 parts by mass to 10 parts by mass, 0.5 parts by mass to 8 parts by mass, or 1 part by mass to 6 parts by mass, relative to 100 parts by mass of the rubber component.

A content of the stearic acid is not particularly limited, and may be, for example, 0 parts by mass to 10 parts by mass, 0.3 parts by mass to 5 parts by mass, or 0.5 parts by mass to 2.5 parts by mass, relative to 100 parts by mass of the rubber component.

Examples of the resin include hydrocarbon resins such as aliphatic hydrocarbon resins, aromatic hydrocarbon resins, and aliphatic/aromatic hydrocarbon resins. A content of the resin is not particularly limited, and may be, for example, 0 parts by mass to 10 parts by mass, 0.5 parts by mass to 6 parts by mass, or 1 part by mass to 3 parts by mass, relative to 100 parts by mass of the rubber component.

A content of the processing aid is not particularly limited, and may be, for example, 0 parts by mass to 10 parts by mass, 1 part by mass to 8 parts by mass, or 2 parts by mass to 6 parts by mass, relative to 100 parts by mass of the rubber component.

The rubber composition according to the present embodiment can be produced by kneading according to a common method by using a mixer such as a Banbury mixer, a kneader, or a roll that is normally used. That is, in a first mixing stage, other additives excluding the vulcanization accelerator and the sulfur are added to and mixed with the rubber component. Next, the vulcanization accelerator and the sulfur can be added to and mixed with the resulting mixture in a final mixing stage to prepare the rubber composition.

The rubber composition thus obtained is used for rim strips of pneumatic tires of various sizes and applications, such as passenger car tires and heavy-duty tires for trucks and buses.

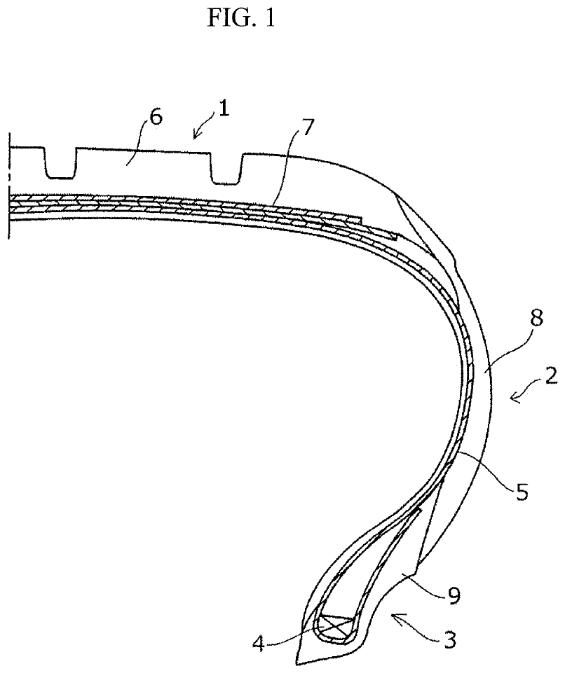

FIG. 1 illustrates an example of a pneumatic tire. The pneumatic tire includes a tread 1, a pair of left and right sidewalls 2 extending radially inward from both ends of the tread 1, and a pair of left and right bead parts 3 provided radially inward of the sidewalls 2. In the pneumatic tire, a carcass ply 5 extending in a toroidal shape is embedded between a pair of bead cores 4 embedded in the pair of bead parts 3. A belt 7 is disposed between the carcass ply 5 and a tread rubber 6 on a radially outer circumference side of the carcass ply 5 of the tread 1. The pneumatic tire includes a rim strip 9 that is disposed in the bead part 3 in a manner of covering a contact area with a rim flange and that forms an outer surface of the tire of the bead part 3. The rim strip 9 is a rubber layer that is continuous with a lower end of a sidewall rubber 8 and is disposed on the outside of the bead part 3.

The rubber composition according to the above embodiment can be molded into a predetermined shape by a common method, for example, by extrusion processing, to obtain an unvulcanized rim strip rubber member. The rim strip rubber member is combined with other members to produce a green tire, which is then vulcanization-molded at, for example, 140° C. to 180° C., and thereby a pneumatic tire can be produced.

### EXAMPLES

Hereinafter, Examples will be shown, but the invention is not limited to these Examples.

Details of raw materials used in Examples and Comparative Examples are as follows.
Natural rubber: RSS #3
Tin-modified polybutadiene rubber: “Nipol BR1250H” manufactured by Zeon Corporation (cis content: 40 mass %, vinyl content: 10 mass % to 13 mass %)
High-cis butadiene rubber: “BR 730” manufactured by ENEOS Materials Corporation
Highly crystalline component-containing polybutadiene rubber: “UBEPOL VCR617” manufactured by UBE Elastomer Co., Ltd. (1,2-syndiotactic polybutadiene crystal content: 17.0 mass %)
Carbon black-1: GPF, “SEAST V” manufactured by TOKAI CARBON CO., LTD. (nitrogen adsorption specific surface area (N₂SA)=27 m²/g)
Carbon black-2: FEF, “SEAST SO” manufactured by TOKAI CARBON CO., LTD. (nitrogen adsorption specific surface area (N₂SA)=42 m²/g)
Carbon black-3: “SEAST N” manufactured by TOKAI CARBON CO., LTD. (nitrogen adsorption specific surface area (N₂SA)=74 m²/g)
Carbon black-4: “N339 SEAST KH” manufactured by TOKAI CARBON CO., LTD. (nitrogen adsorption specific surface area (N₂SA)=93 m²/g)
Carbon black-5: “Diablack A” manufactured by Mitsubishi Chemical Corporation (nitrogen adsorption specific surface area (N₂SA)=137 m²/g)
Silica: “Nipsil AQ” manufactured by Tosoh Silica Corporation (BET specific surface area=205 m²/g)
Oil: “Process NC-140” manufactured by ENEOS Corporation
Wax: “OZOACE 1722” manufactured by NIPPON SEIRO CO., LTD
Zinc oxide: “Zinc oxide type 3” manufactured by Mitsui Mining & Smelting Co., Ltd.
Stearic acid: “LUNAC S-20” manufactured by Kao Corporation
Resin: “Quintone A100” manufactured by Zeon Corporation (aliphatic hydrocarbon resin)
Processing aid: “AKTIPLAST PP” manufactured by Lanxess
Vulcanization accelerator: “Sanceler NS-G” manufactured by Sanshin Chemical Industry Co., Ltd.
Sulfur: “Mucron OT-20” manufactured by Shikoku Chemicals Corporation (sulfur content 80 mass %)

Rubber compositions were prepared using the Banbury mixer according to the formulations (parts by mass) shown in Tables 1 and 2 below. Specifically, first, in the first mixing stage, all additives except for the vulcanization accelerator and the sulfur were added to the rubber component along with the silica and the carbon black, and the mixture was kneaded (discharge temperature: 160° C.). The vulcanization accelerator and the sulfur were added to the obtained kneaded material in the final mixing stage and kneading was performed (discharge temperature=100° C.) to produce the rubber composition. Note that in the sulfur column in the table, the numbers in parentheses indicate the parts by mass of pure sulfur content excluding the mass of oil.

The resulting rubber composition was vulcanized at 160° C. for 30 minutes. The vulcanized rubber samples thus obtained were evaluated for hardness, low heat generation properties, cut resistance, bending fatigue resistance, and abrasion resistance. Evaluation methods are as follows.

### (1) Hardness (23° C.)

The hardness was measured at a temperature of 23° C. using a durometer type A in accordance with JIS K6253-3:2012. A larger value indicates a higher hardness at 23° C. A target hardness is 66 or higher.

### (2) Low Heat Generation Properties

A viscoelasticity tester manufactured by GABO was used to measure a loss factor tan δ of a test piece (2.0 mm×5.0 mm×20.0 mm) at a frequency of 10 Hz, a static strain of 10%, a dynamic strain of 1%, and a temperature of 35° C. (tensile mode). The value of Comparative Example 1 was set to 100, and the values of Examples and Comparative Examples were each indicated as an index. A smaller value indicates a smaller loss factor tan δ, that is, indicates that the sample is less likely to generate heat, and has excellent low heat generation properties (low fuel consumption). A target value (index) for the low heat generation properties is 105 or less.

### (3) Cut Resistance

In accordance with JIS K6252-1:2015, a test piece (thickness 2 mm) was prepared by punching out a crescent shape and making a 0.50±0.08 mm notch in the center of the depression. A tensile test was carried out using a tensile tester manufactured by Shimadzu Corporation at a speed of 500 mm/min to measure the tearing strength of the test piece. The value of Comparative Example 1 was set to 100, and the values of Examples and Comparative Examples were each indicated as an index. A larger value indicates better cut resistance. A target value (index) for the cut resistance is 95 or higher.

### (4) Bending Fatigue Resistance

In accordance with JIS K6260:2017, the test piece was subjected to the De Mattia flex crack growth test at 23° C., and the number of times of the test until the crack grows to 2 mm was measured. A value of 80% of the measured value of Comparative Example 1 was set as a reference value, and the measured value of each of Examples and Comparative Examples was indicated as A if it was greater than the reference value, and as B if it was equal to or less than the reference value.

### (5) Abrasion Resistance

In accordance with JIS K6264-2:2005, an abrasion volume of the test piece was measured using a Pico abrasion tester at a temperature of 23° C., with an applied force of 44 N to the test piece, a turntable rotation speed of 60-2 revolutions per minute, and a turntable rotation times of 80 revolutions. The abrasion resistance index was calculated from the abrasion volume. The value for the abrasion resistance index of Comparative Example 1 was set to 100, and the values of Examples and Comparative Examples were each indicated as an index. A larger value indicates better abrasion resistance. A target value (index) for the abrasion resistance is 95 or higher.

TABLE 1

| | Comp. | Comp. | Comp. | Comp. | Comp. | Comp. | Comp. |
|---|---|---|---|---|---|---|---|
| | Ex. 1 | Ex. 2 | Ex. 3 | Ex 4 | Ex. 5 | Ex. 6 | Ex. 7 |
| Formulation (parts by mass) | | | | | | | |
| Natural rubber | 36 | 36 | 36 | 36 | 36 | 36 | 36 |
| Tin-modified polybutadiene rubber | | 64 | 32 | 64 | 64 | 64 | 64 |
| High-cis butadiene rubber | 64 | | | | | | |
| Highly crystalline component-containing | | | 32 | | | | |
| polybutadiene rubber | | | | | | | |
| Carbon black-1 | | | | | 52 | | |
| Carbon black-3 | 62 | 62 | 62 | 52 | | | 52 |
| Carbon black-3 | | | | | | 52 | |
| Silica | | | | 10 | 10 | 10 | 10 |
| Oil | 1.8 | 1.8 | 1.8 | 1.8 | 1.8 | 1.8 | 1.8 |
| Wax | 2.3 | 2.3 | 2.3 | 2.3 | 2.3 | 2.3 | 2.3 |
| Zinc oxide | 3.5 | 3.5 | 3.5 | 3.5 | 3.5 | 3.5 | 3.5 |
| Stearic acid | 1.5 | 1.5 | 1.5 | 1.5 | 1.5 | 1.5 | 1.5 |
| Resin | 2.0 | 2.0 | 2.0 | 2.0 | 2.0 | 2.0 | 2.0 |
| Processing aid | 4.0 | 4.0 | 4.0 | 4.0 | 4.8 | 4.0 | 4.0 |
| Vulcanization accelerator | 1.3 | 1.3 | 1.3 | 1.3 | 0.9 | 0.9 | 0.6 |
| Sulfur | 2.6 (2.08) | 2.6 (2.08) | 2.6 (2.08) | 2.6 (2.08) | 2.6 (2.08) | 2.6 (2.08) | 2.6 (2.08) |
| Mass ratio of vulcanization | 0.63 | 0.63 | 0.63 | 0.63 | 0.43 | 0.43 | 0.29 |
| accelerator sulfur | | | | | | | |
| Evaluation | | | | | | | |
| Hardness | 69 | 69 | 75 | 69 | 61 | 71 | 64 |
| Low heat generation properties (index) | 100 | 93 | 109 | 93 | 80 | 106 | 96 |
| Cut resistance (index) | 100 | 60 | 53 | 90 | 87 | 154 | 151 |
| Bending fatigue resistance | A | B | B | B | B | A | A |
| Abrasion resistance (index) | 100 | 94 | 121 | 96 | 52 | 97 | 91 |

TABLE 2

| | Ex. 1 | Ex. 2 | Ex. 3 | Ex. 4 | Ex. 5 | Ex. 6 | Ex. 7 |
|---|---|---|---|---|---|---|---|
| Formulation (parts by mass) | | | | | | | |
| Natural rubber | 36 | 36 | 50 | 36 | 36 | 36 | 50 |
| Tin-modified polybutadiene rubber | 64 | 64 | 50 | 64 | 64 | 64 | 50 |
| Carbon black-2 | | | | 26 | | 67 | |
| Carbon black-3 | 52 | 52 | 52 | | | | |
| Carbon black-4 | | | | 26 | 48 | | 55 |
| Silica | 10 | 10 | 10 | 10 | 10 | 10 | 10 |
| Oil | 1.8 | 1.8 | 1.8 | 1.8 | 1.8 | 1.8 | 1.8 |
| Wax | 2.3 | 2.3 | 2.3 | 2.3 | 2.3 | 2.3 | 2.3 |
| Zinc oxide | 3.5 | 3.5 | 3.5 | 3.5 | 3.5 | 3.5 | 3.5 |
| Stearic acid | 1.5 | 1.5 | 1.5 | 1.5 | 1.5 | 1.5 | 1.5 |
| Resin | 2.0 | 2.0 | 2.0 | 2.0 | 2.0 | 2.0 | 2.0 |
| Processing aid | 4.0 | 4.0 | 4.0 | 4.0 | 4.0 | 4.0 | 4.0 |
| Vulcanization accelerator | 0.9 | 0.9 | 0.9 | 0.9 | 0.9 | 0.9 | 1.7 |
| Sulfur | 2.6 (2.08) | 2.2 (1.76) | 2.2 (1.76) | 2.6 (2.08) | 2.6 (2.08) | 2.6 (2.08) | 3.8 (3.04) |
| Mass ratio of vulcanization | 0.43 | 0.51 | 0.51 | 0.43 | 0.43 | 0.43 | 0.56 |
| accelerator sulfur | | | | | | | |
| Evaluation | | | | | | | |
| Hardness | 66 | 66 | 67 | 68 | 70 | 72 | 69 |
| Low heat generation properties (index) | 94 | 94 | 94 | 92 | 93 | 94 | 90 |
| Cut resistance (index) | 118 | 134 | 153 | 129 | 95 | 97 | 99 |
| Bending fatigue resistance | A | A | A | A | A | A | A |
| Abrasion resistance (index) | 96 | 95 | 95 | 96 | 95 | 96 | 96 |

Results are shown in Tables 1 and 2. Comparative Example 1 is an example in which no tin-modified polybutadiene rubber and silica were compounded, and the vulcanization accelerator and the sulfur were compounded such that the mass ratio of the vulcanization accelerator to the sulfur (hereinafter may simply be referred to as the mass ratio) was greater than the upper limit value. Comparative Example 2 is an example in which the high-cis butadiene rubber of Comparative Example 1 was replaced with a tin-modified polybutadiene rubber. In Comparative Example 2, the hardness was equivalent to that of Comparative Example 1, and the low heat generation properties was improved, but the cut resistance, bending fatigue resistance, and abrasion resistance were deteriorated.

Comparative Example 3 is an example in which the high-cis butadiene rubber of Comparative Example 1 was replaced with a tin-modified polybutadiene rubber and a highly crystalline component-containing polybutadiene rubber. In Comparative Example 3, the hardness and abrasion resistance were improved as compared with those of Comparative Example 1, but the low heat generation properties, cut resistance, and bending fatigue resistance were deteriorated.

Comparative Example 4 is an example in which the vulcanization accelerator and the sulfur were compounded such that the mass ratio was greater than the upper limit value. In Comparative Example 4, the hardness and abrasion resistance were equivalent to those of Comparative Example 1, and the low heat generation properties was improved, but the cut resistance and bending fatigue resistance were deteriorated.

Comparative Example 5 is an example in which carbon black having a nitrogen adsorption specific surface area (N₂SA) lower than the lower limit value was compounded. In Comparative Example 5, the low heat generation properties was improved as compared with that of Comparative Example 1, but the hardness, cut resistance, bending fatigue resistance, and abrasion resistance were deteriorated.

Comparative Example 6 is an example in which carbon black having a nitrogen adsorption specific surface area (N₂SA) greater than the upper limit value was compounded. In Comparative Example 6, the hardness, bending fatigue resistance, and abrasion resistance were equivalent to those of Comparative Example 1, and the cut resistance was improved, but the low heat generation properties was deteriorated.

Comparative Example 7 is an example in which the vulcanization accelerator and the sulfur were compounded such that the mass ratio was lower than the lower limit value. In Comparative Example 7, the low heat generation properties and bending fatigue resistance were equivalent to those of Comparative Example 1, and the cut resistance was improved, but the hardness and abrasion resistance were deteriorated.

In contrast, in Examples 1 to 7, the hardness, cut resistance, bending fatigue resistance, and abrasion resistance were all equivalent to or better than those of Comparative Example 1, and the low heat generation properties was improved.

Note that in various numerical ranges described in the specification, upper limit values and lower limit values thereof can be freely combined, and all combinations thereof are described in the present specification as preferable numerical ranges. The description of the numerical range of “X to Y” means X or more and Y or less.

### REFERENCE SIGNS LIST

1: tread
2: sidewall
3: bead part
4: bead core
5: carcass ply
6: tread rubber
7: belt
8: sidewall rubber
9: rim strip

What is claimed is:

1. A rubber composition for a rim strip, comprising:
a rubber component containing a tin-modified polybutadiene rubber;
silica;
carbon black having a nitrogen adsorption specific surface area (N₂SA) of 35 m²/g to 100 m²/g;
a vulcanization accelerator; and
sulfur, wherein
a mass ratio of the vulcanization accelerator to the sulfur is 0.40 to 0.60.

2. The rubber composition for a rim strip according to claim 1, wherein
relative to 100 parts by mass of the rubber component, a content of the silica is 3 parts by mass to 30 parts by mass, a content of the carbon black is 40 parts by mass to 80 parts by mass, and a content of the sulfur is 1 part by mass to 5 parts by mass.

3. The rubber composition for a rim strip according to claim 1, wherein
100 parts by mass of the rubber component contains 40 parts by mass to 80 parts by mass of the tin-modified polybutadiene rubber and 20 parts by mass to 60 parts by mass of a natural rubber.

4. The rubber composition for a rim strip according to claim 1, wherein
the silica has a BET specific surface area of 180 m²/g to 230 m²/g.

5. The rubber composition for a rim strip according to claim 1, wherein
relative to 100 parts by mass of the rubber component, a total content of the carbon black and the silica is 45 parts by mass to 100 parts by mass.

6. The rubber composition for a rim strip according to claim 1, wherein
a content ratio of the carbon black to the silica (carbon black/silica) is 2 to 10 in terms of mass ratio.

7. The rubber composition for a rim strip according to claim 1, wherein
the vulcanization accelerator includes a sulfenamide-based vulcanization accelerator.

8. A pneumatic tire using the rubber composition for a rim strip according to claim 1 in a rim strip.
